(19) United States
(12) Patent Application Publication
(10) Pub. No.: US 2004/0172643 A1
(43) Pub. Date: Sep. 2, 2004

(54) Optical head device, optical disk apparatus using optical head device, and heat radiation mechanism

(75) Inventor: Hiroshi Shinozuka, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/787,760

(22) Filed: Feb. 27, 2004

(30) Foreign Application Priority Data
Feb. 28, 2003 (JP) 2003-054680

(51) Int. Cl. G11B 7/08; G11B 7/085; G11B 7/09; G11B 7/00

(52) U.S. Cl. 720/681; 369/121; 720/671

(57) ABSTRACT

The invention provides an optical head device and an optical disk apparatus in which characteristics are not changed even if the temperature changes. Change in light-emitting characteristics caused by heat generation is suppressed by connecting a pin of a semiconductor laser element to a land for heat radiation at a connecting area.

### CROSS-REFERENCE TO RELATED APPLICATIONS

This application is based upon and claims the benefit of priority from prior Japanese Patent Application No. 2003-54680, filed Feb. 28, 2003, the entire contents of which are incorporated herein by reference.

### BACKGROUND OF THE INVENTION

1. Field of the Invention

The present invention relates to an optical head device and an optical disk apparatus for recording information on an optical disk serving as an information recording medium and reproducing the information from the optical disk.

2. Description of the Related Art

In an optical disk serving as an information recording medium, a read-only optical disk typified by a CD (compact disc for music) and DVD-ROM, a write-once optical disk typified by a CD-R and DVD-R, a rewritable optical disk typified by an external memory of a computer and a recording/reproducing video disk, and the like have already been put into practical use.

In recent years, in order to correspond to the rapid increase in recording capacity required in information- and broadcast-related instruments, an increase in the recording capacity is demanded in the optical disk. Therefore, while research is going on to decrease the focusing spot diameter by reducing the laser beam wavelength (decrease in a focus spot diameter) or to utilize a super-resolution technology in order to increase the recording density, a mastering technology such electron beam exposure has been studied in order to reduce the track pitch and mark pit pitch.

Therefore, an optical head device which records information on an optical disk and reproduces the information from the optical disk is burdened with strict design conditions. For example, in order to record information at 8× to 48× speed using the miniaturized optical head device having decreased thickness, an increase in laser output is required. However, the increase in laser output means an increase in heat generated from a laser device. Although it is also necessary to improve processing speed in a signal processing unit in order to realize high disk rotation speed, the heat generation is also increased.

In the components (elements) used for the optical head device, there are components (elements) whose characteristics fluctuate when the ambient temperature is changed. In particular, it is well known that semiconductor laser elements exhibit a fluctuation in characteristics such as fluctuation in wavelength of the output laser beam caused by heat generation of the semiconductor laser element itself. In most cases, a heat radiation mechanism such as a heat sink is added to the semiconductor laser element.

In Jpn. Pat. Appln. KOKAI Publication No. 8-204293, there is an example of a heat-radiatable substrate structure for electronic components in which a component having large heat radiation characteristics is mounted on an electrically conductive thin plate (copper foil pattern) having a heat radiating area which can cover the calorific capacity of the electronic component as a part of a wiring pattern.

In the invention disclosed in Jpn. Pat. Appln. KOKAI Publication No. 8-204293, it is necessary to make through holes for connection in order to provide a copper foil pattern 20 on almost the whole area of a substrate 10. Further, there is a problem that a component in which insulating characteristics are required is not directly arranged.

As a result, there is a problem that the cost is increased. There is also a problem that part of the heat diffused by the copper foil pattern 20 heats the component mounted on the copper foil pattern again. The increase in the copper foil pattern for securing a heat radiation volume runs counter to miniaturization of the device.

In other technical fields, a method in which a solid layer (heat radiation layer) is provided by forming a multilayered substrate and the heat is indirectly radiated. However, this method complicates the substrate and increases the cost.

As described above, in order to stably exert the performance of the electronic component or the laser element, it is necessary to suppress temperature rise of a heat source in such a manner that heat is diffused by successfully transferring the heat of the heat source. As the miniaturization of the devices proceeds, the method in which the heat is thermal-diffused in high-density packaging is required without increasing the component for heat radiation.

### BRIEF SUMMARY OF THE INVENTION

According to an aspect of the present invention, there is provided a heat radiation mechanism comprising: a heat source which generates heat by being supplied with an actuating signal or driving current; a circuit board which provides at least the actuating signal or the driving current to the heat source; a connecting portion which connects the heat source to the circuit board while electrical continuity is secured; a heat sink which diffuses heat generated by the heat source; and a heat radiating element which includes a portion having a large area or a large volume which is connected to or in contact with the connecting portion and diffuses head generated by the heat source.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view illustrating an example of an optical disk apparatus to which an embodiment of the invention is applied;

FIG. 2 is a schematic view illustrating an example of an optical pickup which is incorporated in the optical disk apparatus shown in FIG. 1;

FIG. 3 is a block diagram illustrating an example of a signal processing system in the optical disk apparatus and an optical head device shown in FIGS. 1 and 2;

FIG. 4 is a schematic view illustrating an example of the optical head device which is incorporated in the optical disk apparatus shown in FIGS. 2 and 3;

FIGS. 5A and 5B are schematic views illustrating an example of a light-emitting/receiving unit for DVD (DVD-IOU) which is incorporated in the optical head device shown in FIG. 2;

FIG. 6 is a schematic view illustrating an example of a configuration in which the light-emitting/receiving unit for DVD shown in FIGS. 5A and 5B is mounted on the optical head device shown in FIG. 2;

FIG. 7 is a schematic view illustrating an example of a connecting portion which can supply driving current and an actuating signal to a power supply unit, i.e., a semiconductor laser element in the DVD-IOU shown in FIGS. 5A and 5B;

FIGS. 8A and 8B are schematic views illustrating an example of the connecting portion which can supply the driving current and the actuating signal to the power supply unit, i.e., the semiconductor laser element in the DVD-IOU shown in FIGS. 5A and 5B;

FIGS. 9A and 9B are schematic views illustrating an example of a connecting structure when a land (heat radiating area) shown in FIGS. 7, 8A and 8B is connected to a metal member having higher heat radiation characteristics; and

FIGS. 10A and 10B are schematic views illustrating an example of the connecting structure when the land (heat radiating area) shown in FIGS. 7, 8A and 8B is connected to the metal member having the higher heat radiation characteristics.

### DETAILED DESCRIPTION OF THE INVENTION

Referring to the accompanying drawings, embodiments of the invention will be described in detail below.

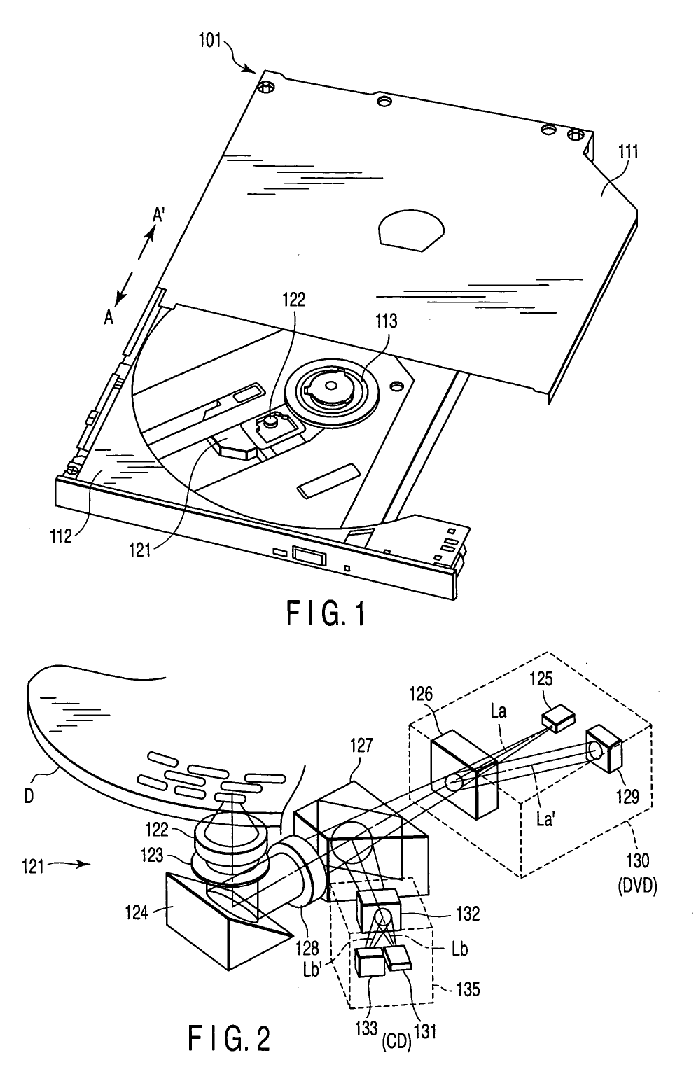

FIG. 1 is a schematic view illustrating an example of an optical disk apparatus including an optical pickup according to the embodiment of the invention.

An optical disk apparatus 101 shown in FIG. 1 includes a housing 111 and a table unit 112 which is formed to be able to perform an eject operation (movement in a direction of an arrow A) and loading operation (movement in a direction of an arrow A′) relative to the housing 111.

A turntable 113 which rotates an optical disk D at a predetermined number of revolutions is provided in the substantial center of the table unit 112. Since FIG. 1 shows a case in which the table unit 112 is ejected while the optical disk D is not inserted, a part of an optical pickup 121 and an objective lens 122 incorporated in the optical pickup 121 can be seen with the optical pickup 121 and the objective lens 122 exposed.

FIG. 2 is a schematic view illustrating an operating principle of the optical pickup 121 while extracting elements of the optical pickup 121 in the optical disk apparatus 101 shown in FIG. 1.

As shown in FIG. 2, the optical pickup 121 includes the objective lens 122 which focuses the light beam, i.e., the laser beam onto a recording surface of the optical disk D and takes in the laser beam reflected from the optical disk D (hereinafter referred to as reflected laser beam).

A first holographic element 123 is provided at a predetermined position on the side of the objective lens 122 which is opposite the optical disk D. The first holographic element 123 gives predetermined optical characteristics to the laser beam directed toward the optical disk D through the objective lens 122 and the reflected laser beam from the optical disk D.

The objective lens 122 and the first holographic element 123 can be arbitrarily moved in a direction orthogonal to the recording surface of the optical disk D (focus direction) and in a direction orthogonal to a guide groove or a recording mark string provided in the recording surface (tracking direction) with a triple actuator (not described in detail).

A prism mirror 124 is provided at the predetermined position in front of a dichroic filter (the first holographic element) 123, i.e., on the side opposite from the objective lens 122. The prism mirror 124 reflects the laser beam guided in the direction substantially parallel to the recording surface of the optical disk D toward the objective lens 122.

A first laser element 125 is provided at a position where the laser beam can be incident on the prism mirror 124. The first laser element 125 outputs the laser beam having, e.g., the near infrared wavelength toward the direction substantially parallel to the recording surface of the optical disk D. For example, the first laser element 125 is employed to reproduce information from a DVD standard optical disk and to write information in a CD standard optical disk and the DVD standard optical disk.

A light-receiving characteristics setting element 126 in which a diffraction grating and a non-polarizing hologram are integrally formed, a dichroic prism 127, and a collimate lens 128 are provided between the first laser element 125 and the prism mirror 124 in order from the side of the laser element 125. A first photodetector 129 for detecting the reflected laser beam from the optical disk D is located at a position satisfying a predetermined condition for the position where the first laser element 125 is provided. The reflected laser beam to which the light-receiving characteristics setting element 126 gives predetermined diffraction is incident on the first photodetector 129.

The first laser element 125, the light-receiving characteristics setting element 126, and the first detector 129 are integrated in the form of a light-emitting/receiving unit for DVD (hereinafter referred to as DVD-IOU) 130. The DVD-IOU 130 is integrally assembled with the first laser element 125, and the DVD-IOU 130 also includes a heat sink 120 which diffuses the heat generated from the first laser element 125.

A second laser element 131, which outputs the laser beam having, e.g., the near infrared wavelength, is provided at a position where the laser beam can be incident on the prism mirror 124 by the reflection from the dichroic prism 127. For example, the second laser element 131 is employed to reproduce information from a CD standard optical disk.

An FM holographic element 132 is located at a predetermined position between the second laser element 131 and the dichroic prism 127. The FM holographic element 132 gives the characteristics suitable for information recording in the optical disk D to the laser beam outgoing from the second laser element 131. The FM holographic element 132 also has a function of giving predetermined light-receiving characteristics to the reflected laser beam from the optical disk D.

A second photodetector 133 detecting the reflected laser beam from the optical disk D is provided at a position satisfying the predetermined condition for the position where the second laser element 131 is provided. The reflected laser beam to which the FM holographic element 132 gives the predetermined diffraction is incident on the second photodetector 133. The second laser element 131, the FM holographic element 132, and the second photodetector 133 are integrated in the form of a light-emitting/receiving unit for CD (hereinafter referred to as CD-IOU) 135.

In the case where information is recorded in the DVD family optical disk using the optical head device 121 shown in FIG. 2, the light-receiving characteristics setting element 126 gives predetermined wavefront characteristics to a laser beam La having the wavelength of, e.g. 660 nm output from the first laser element 125, and the laser beam La is incident on the dichroic prism 127. The laser beam La is transmitted through the dichroic prism 127 and collimated with the collimating lens 128, and a traveling direction of the laser beam La is folded toward the objective lens 122 by the prism mirror 124. The laser beam La directed toward the objective lens 122 by the prism mirror 124 passes through the first holographic element 123, and the laser beam La is focused on the recording surface of the optical disk D.

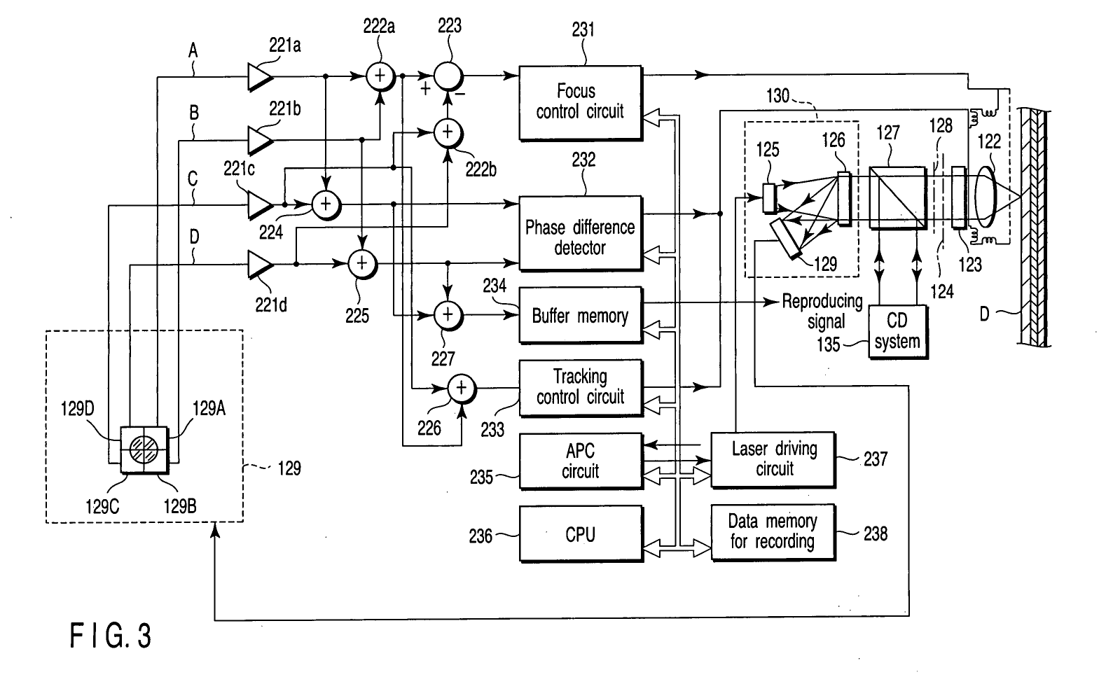

Light intensity of the laser beam La focused on the recording surface of the optical disk D has been modulated according to information to be recorded by a signal processing system described later referring to FIG. 3, so that a recording mark, i.e. a pit is formed in a recording film when energy per time is sufficient to generate phase transition of the recording film in the optical disk D.

A reflected laser beam La' which has been reflected on the recording surface of the optical disk D returns to the prism mirror 124 through the first holographic element 123, and the traveling direction of the laser beam La' is folded in substantially parallel to the recording surface of the optical disk D again.

The reflected laser beam La' folded by the prism mirror 124 is incident on the collimating lens 128 and guided to the dichroic prism 127.

Then, the reflected laser beam La' is transmitted through the dichroic prism 127 and directed toward the first photodetector 129 by the light-receiving characteristics setting element 126.

Part of the reflected laser beam La' which has been incident on the first photodetector 129 is utilized to generate a focus error signal and a tracking error signal in the signal processing system shown in FIG. 3. That is, while the objective lens 122 is locked at a position where the objective lens 122 is focused on the recording surface of the optical disk D, tracking is controlled so that the center of the laser beam corresponds to the center of the track or the pit string of information pits, which is previously formed in the recording surface of the optical disk D.

In the case where the information is reproduced from the DVD standard optical disk, in the same way as the information recording described above, the laser beam La focused on the recording surface of the optical disk D is reflected from the optical disk D while the intensity of the reflected laser beam La is changed according to the recording mark (pit string) recorded on the recording surface.

The reflected laser beam La' which has been reflected on the recording surface of the optical disk D returns to the prism mirror 124 through the first holographic element 123, and the traveling direction of the laser beam La' is folded in substantially parallel to the recording surface of the optical disk D again.

The laser beam La' folded by the prism mirror 124 is incident on the collimating lens 128 and guided to the dichroic prism 127.

Then, the reflected laser beam La' is transmitted through the dichroic prism 127 and directed toward the first photodetector 129 by the light-receiving characteristics setting element 126.

In the signal processing system shown in FIG. 3, part of the reflected laser beam La' incident on the first photodetector 129 is output to an external device or a temporary storage device in the form of a signal corresponding to a reproducing signal obtained by adding the output of the first photodetector 129.

In the case where the information is recorded in the CD standard optical disk, the FM holographic element 132 gives the predetermined wavefront characteristics to a laser beam Lb having the wavelength of, e.g. 780 nm output from the second laser element 131, and the laser beam Lb is incident on the dichroic prism 127.

The laser beam Lb which has been incident on the dichroic prism 127 is reflected from the dichroic prism 127 and guided to the collimating lens 128.

The laser beam Lb guided to the collimating lens 128 is collimated by the collimating lens 128, and the traveling direction of the laser beam Lb is folded toward the objective lens 122 by the prism mirror 124.

The laser beam Lb directed toward the objective lens 122 by the prism mirror 124 is focused on the recording surface of the optical disk D through the first holographic element 123.

The reflected laser beam Lb' which has been reflected on the recording surface of the optical disk D returns to the prism mirror 124 through the first holographic element 123, and the traveling direction of the laser beam Lb' is folded in substantially parallel to the recording surface of the optical disk D again. The laser beam Lb' returns to the dichroic prism 127 through the collimating lens 128.

Then, the reflected laser beam Lb' is reflected on the dichroic prism 127 and directed toward the second photodetector 133 with the FM holographic element 132.

Accordingly, the reflected laser beam Lb' is incident on the second photodetector 133 while the intensity of the reflected laser beam Lb' is changed according to the information recorded in the optical disk D.

The reflected laser beam Lb' is photoelectrically converted by the second photodetector 133, and the photoelectrically converted signal is processed by the signal processing system shown in FIG. 3 and output to the external device or the temporary storage device in the form of a signal corresponding to the information recorded in the optical disk D.

FIG. 3 is a block diagram illustrating an example of the signal processing system in the optical disk apparatus shown in FIGS. 1 and 2. In FIG. 3, the reproduction of the signal from the CD standard optical disk (the laser beam which passes the dichroic prism) will be omitted, and the output signal of the second photodetector, i.e. the reproducing signal from the DVD standard optical disk, focus control, and tracking control will be mainly described.

The second photodetector 133 includes first to fourth area photodiodes 133A, 133B, 133C, and 133D. Outputs A, B, C, and D of the respective photodiodes 133A to 133D are amplified to a predetermined level by first to fourth amplifiers 221a, 221b, 221c, and 221d, respectively.

In the outputs A to D of the respective amplifiers 221a to 221d, the outputs A and B are added by a first adder 222a and the outputs C and D are added by a second adder 222b.

The outputs of the adders 222a and 222b are added by an adder 223, while a sign of the outputs C and D is reversed to the outputs A and B. That is, the outputs C and D are subtracted from the output A and B by the adder 223.

The result of the addition (subtraction) of the adder 223 is supplied to a focus control circuit 231 in the form of a focus error signal. The focus error signal is utilized in order that the position of the objective lens 122 corresponds to a focal distance where the laser beam is focused through the objective lens 122 on the track (not shown) previously formed in the recording surface of the optical disk D or the pit string (not shown) which is of the recording information.

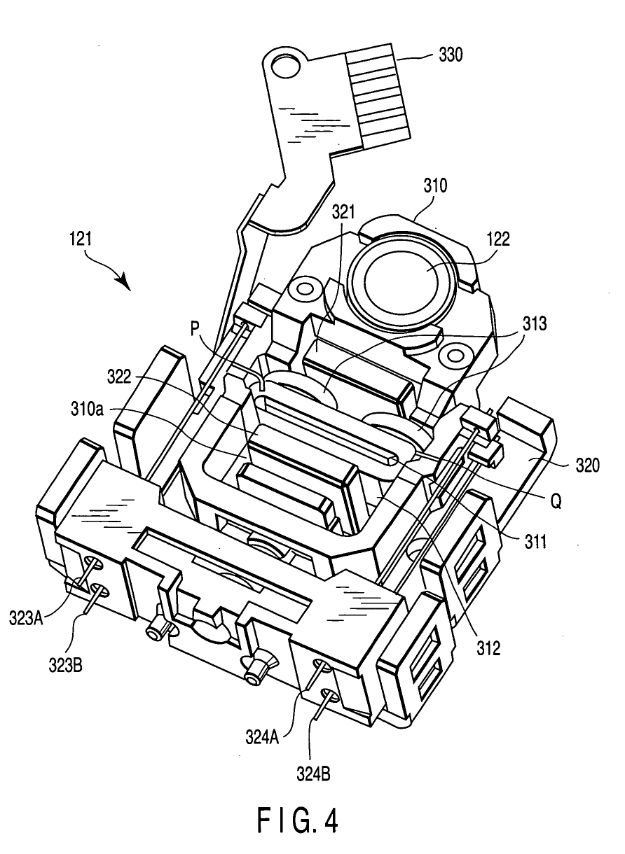

The objective lens 122 is held at on-focus state on a predetermined track or pit string of the recording surface in the optical disk D in such a manner that a lens holder 310 (see FIG. 4) is moved in a predetermined direction by thrust generated from focus control current which is supplied to a focus coil 312 (see FIG. 4) from the focus control circuit 231 on the basis of the focus error signal.

An adder 224 generates (A+C), and an adder 225 generates (B+D). The outputs (A+C) and (B+D) of the adders 224 and 225 are inputted to a phase difference detector 232. The phase difference detector 232 is useful for obtaining the accurate tracking error signal in the case where the objective lens 122 is lens-shifted.

The sum of (A+B) and (C+D) is obtained by an adder 226, and the result is supplied to a tracking control circuit 233 in the form of a tracking error signal. The tracking error signal is utilized in order that the position of the objective lens 122 corresponds to center of the track (not shown) previously formed in the recording surface of the optical disk D or to the center of the pit string (not shown) which is of the recording information and the objective lens 122 is moved in the direction parallel to the recording surface of the optical disk D.

The objective lens 122 is held at on-track state on a predetermined track or pit string of the recording surface in the optical disk D in such a manner that a lens holder 310 is moved in a predetermined direction by thrust generated from tracking control current which is supplied to a tracking coil 313 (see FIG. 4) from the tracking control circuit 233 on the basis of the tracking error signal.

(A+C) and (B+D) are further added by an adder 227, converted into an (A+B+C+D) signal, i.e. the reproducing signal, and input to a buffer memory 234.

The intensity of optical feedback of the laser beam outgoing from the first laser element 125 is input to an APC circuit 235.

Accordingly, the intensity of the recording laser beam outgoing from the first laser element 125 on the basis of the recording data stored in a recording data memory 238 is stabilized.

In the optical disk apparatus 101 having the above-described signal detection system, when the optical disk D is mounted on the turntable 113 and a predetermined routine is started under the control of a CPU 236, the recording surface of the optical disk D is irradiated with the reproducing laser beam from the first laser element 125 by control of a laser driving circuit 237.

Then, the reproducing laser beam is continuously emitted from the first laser element 125. Although the detailed description is omitted, signal reproducing operation is started.

As shown in FIG. 4, the focus coil 312 and the tracking coil 312 are located in the optical head device 121. The focus coil 312 is provided at the substantial center of an actuator 310 having an opening 310a while being about a magnetic material 311. The tracking coil 313 is provided at a side face on the objective lens 122 side of the focus coil 312 while the tracking coil 313 is bonded to the focus coil 312 or closed to the focus coil 312.

The actuator 310 is supported through four wire members (elastic members) 323A, 323B, 324A, and 324B provided at predetermined positions of an actuator base 320 while the actuator 310 can be moved in an arbitrary direction in a space defined by the opening 310a.

Focus control current and tracking control current are supplied to the focus coil 312 and the tracking coil 313 through a flat cable (FPC) 330 connected to a driving circuit board (not shown) at a predetermined position of an optical base 151 described later referring to FIG. 6.

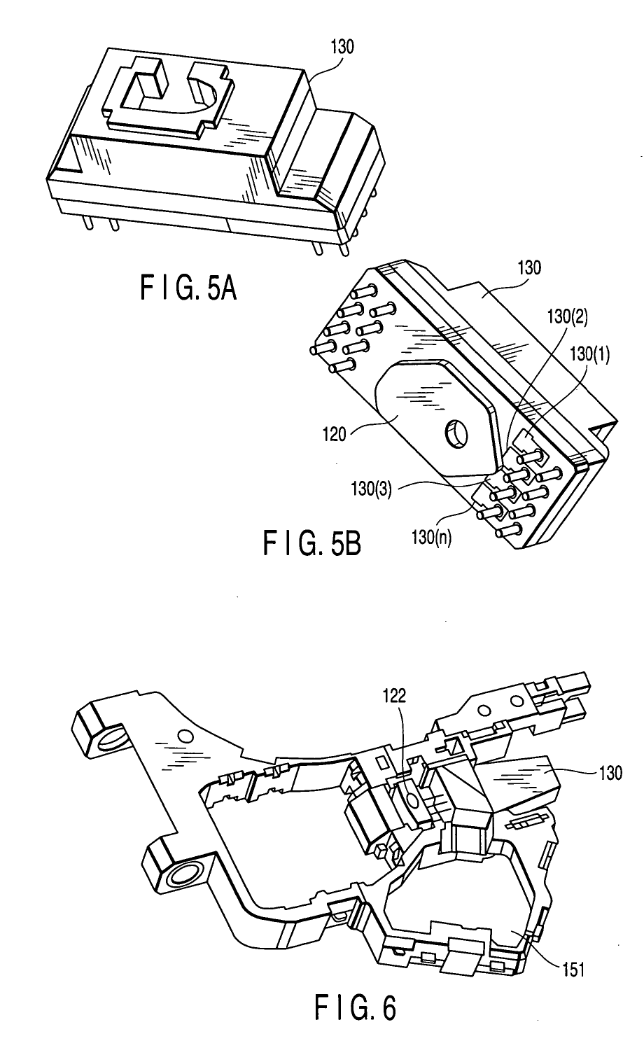

FIGS. 5A and 5B illustrate the light-emitting/receiving unit for DVD (DVD-IOU) while the DVD-IOU is extracted from the optical head device and the optical disk apparatus shown in FIGS. 2 and 3. As shown in FIGS. 5A and 5B, the DVD-IOU 130 holds the first laser element 125 emitting the laser beam having the wavelength of 660 nm at a predetermined position of a housing 130a. The DVD-IOU 130 is fixed at the predetermined position of the optical base 151 as shown in FIG. 6. A part of the heat sink 120 is exposed at a predetermined position of the DVD-IOU 130.

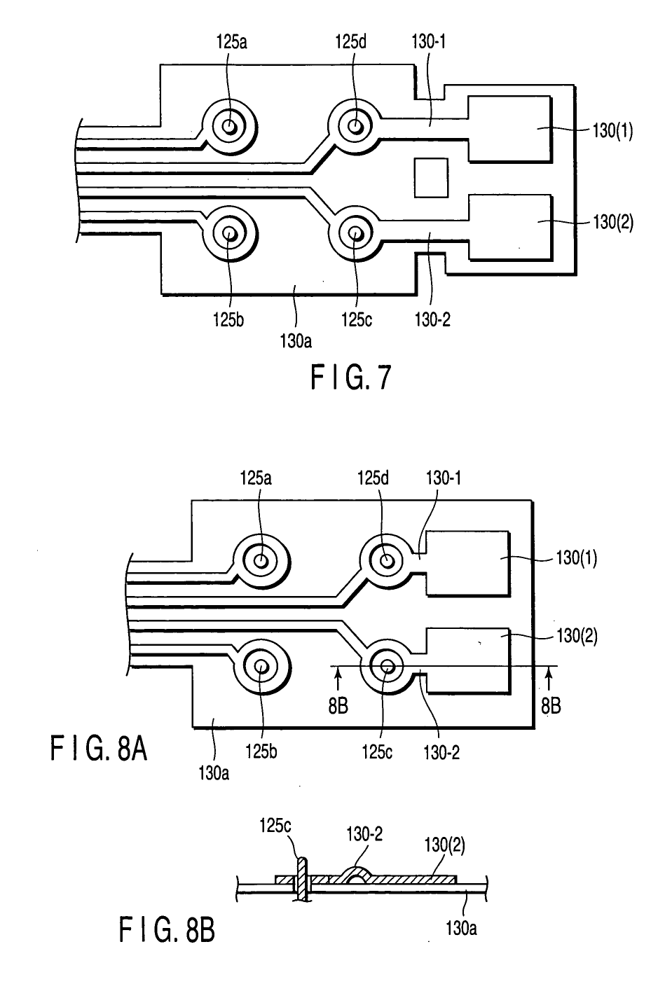

FIGS. 7, 8A and 8B schematically show a connecting portion which can supply driving current and an actuating signal to a power supply unit, i.e., a semiconductor laser element in the DVD-IOU shown in FIGS. 5A and 5B.

As can be seen from FIG. 7, the first laser element 125 is electrically connected to the laser driving circuit 237 illustrated in FIG. 3 through the connecting portions (for example, pins) 125a, 125b, . . . , 125n which can supply the driving current and the actuating signal (for the sake of convenience, only four pins are shown in FIG. 7) at a predetermined position of the DVD-IOU 130.

Each of the connecting portions 125a, 125b, . . . , 125n of the first laser element 125 is connected to each of heat radiating areas (land) 130(1), 130(2), . . . , 130(n) which are of a main part of the housing 130a, i.e. a large area suitable for the heat radiation (for the sake of convenience, only two areas are shown in FIG. 7) through each of connecting areas 130-1, 130-2, . . . , 130-n which are provided in the housing 130a (for the sake of convenience, only four area are shown in FIG. 7).

Each of the heat radiating areas (land) 130(1), 130(2), . . . , 130(n) is utilized for supplying electric power to a laser element (mounted component) or transmission of the signal processing, and a member having low electric loss is selected for the heat radiating areas (lands) 130(1), 130(2), . . . , 130(n). Generally, the member having the low electric loss also has good thermal conductivity. In many cases, since the land can also diffuse the heat by volume itself of the material, when the land connected to the connecting areas 130-1, 130-2, . . . , 130-n are formed by the substrate or a die-cast component, high heat radiation effect can be expected.

For example, the thermal conductivity of air is about 25 mW/m·° C. at room temperature and atmospheric pressure. On the other hand, the thermal conductivity of copper (copper foil pattern) used for the land is 398 mW/m·° C. in pure metal value, and the heat radiation characteristics are very high.

Temperature rise ΔT [° C.] in air-cooling can be determined at a rough estimate by the following equation:

ΔT=W/(D·S)

where W is electric power consumption [W], D is thermal conductivity [W/m·° C.], and S is a surface area of the component.

As shown in the above equation, in order to suppress the temperature rise while the electric power consumption is constant, it is necessary that the material having the higher thermal conductivity comes into contact with the heat source or the surface area of the component to be cooled is increased.

Therefore, as shown in FIG. 7, the external connecting pins 125a, 125b, . . . , 125n of the component which is of the heat source, i.e. the semiconductor laser element 125 can be regarded as a member which directly thermal-diffuses the heat radiated by the member itself. Further, the higher heat radiation characteristic can be obtained by increasing the areas of the lands 130(1), 130(2), . . . , 130(n) connected to the external connecting pins 125a, 125b, . . . , 125n.

As shown in FIG. 8A, in the case where the pins 125a, 125b, . . . , 125n are connected to the connecting areas 130-1, 130-2, . . . , 130-n by a connecting medium such as solder which can secure the electrical contact, the connecting medium such as the solder can be prevented from running into the lands 130(1), 130(2), . . . , 130(n) by decreasing a width (referred to as width, because FIG. 8A is a plan view) of the connecting areas 130-1, 130-2, . . . , 130-n which connect the lands 130(1), 130(2), . . . , 130(n) and the pins 125a, 125b, . . . , 125n.

In this case, as shown in FIG. 8B, in the connecting areas 130-1, 130-2, . . . , 130-n (the lands 130(1), 130(2), . . . , 130(n) may be included), the thickness may be changed on the way to the lands 130(1), 130(2), . . . , 130(n).

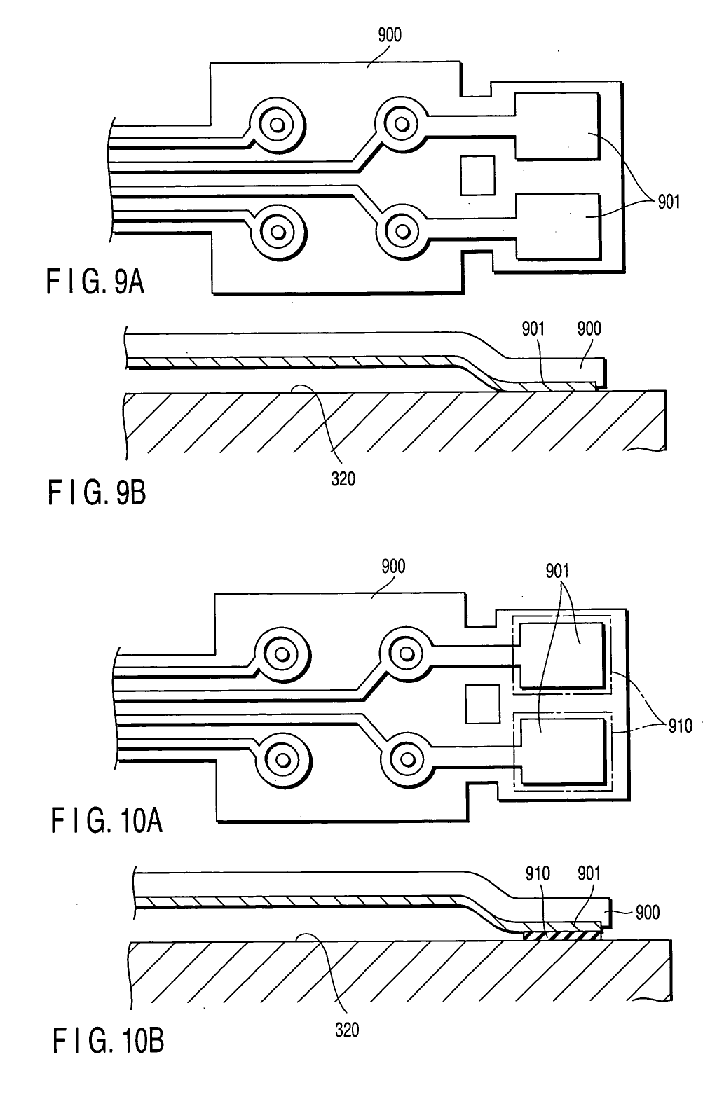

FIGS. 9A and 9B are schematic views illustrating an example of a connecting structure when the land (heat radiating area) described referring to FIGS. 7, 8A and 8B is connected to a metal member having the higher heat radiation characteristic.

As shown in FIGS. 9A and 9B, in the case where lands 901(1), 901(2), . . . , 901(n) are formed by FPC900 which is a flexible resin film or a thin resin substrate, the higher heat radiation characteristic can be obtained by connecting (fixing) the land to a predetermined area of the metal member.

For example, the actuator base 320 used for the optical head device shown in FIG. 4 is frequently made of a metal or an alloy typified by Zn (zinc), Al (aluminum), Mg (magnesium), and like in order to increase accuracy of form.

The thermal conductivity of each material is as follows;

the thermal conductivity of Zn (zinc) is 121 mW/m·° C. in pure metal value;

the thermal conductivity of Al (aluminum) is 237 mW/m·° C. in pure metal value;

the thermal conductivity of Mg (magnesium) is 156 mW/m·° C. in pure metal value; and

the thermal conductivity of Sn-50Pb lead solder is 46.5 mW/m·° C.

Each of thermal conductivities is higher than that of air, so that the effect of diffusing the heat of the heat source is obtained by the contact.

Accordingly, in the case where the land (heat radiating area) shown in FIGS. 7, 8A and 8B is provided in the FPC which is the flexible resin film or the thin resin substrate such that the focus coil 312 and the tracking coil 313 of the optical head device shown in FIG. 4 are connected to the connecting portion provided at a predetermined position of the base 320, the higher heat radiation characteristic can be obtained by connecting (fixing) the land to a predetermined area of the base 320.

In the case where the insulating characteristics are required between the land and the base (metal member), as shown in FIG. 10B, a spacer 910 made of a ceramic material, which has the high thermal conductivity and exhibits the insulating characteristics, may be inserted between the land and the base.

As described above, in order to suppress the temperature rise caused by the heating component, the limited space is utilized and the higher heat radiation characteristics are obtained without increasing the component area of the heat sink in such a manner that the widely used heat sink comes in contact with the heat source and the land for heat radiation is connected to the pin of the component which becomes the heat source, i.e., the semiconductor laser element.

In the above-described embodiments, although the light-emitting/receiving unit for writing the information in the DVD standard optical disk has been described as an example, needless to say, the invention can be also applied to a laser unit including a laser element for reproducing the information from the CD standard optical disk.

As described above, according to the invention, by extending the area of the land portion, the temperature rise of the heat source can be suppressed, and an optical head having stable performance can be produced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical head device comprising:
a light source which emits a light beam;
a connecting portion which can supply at least an actuating signal or driving current to the light source; and
a heat radiating element which is connected to the connecting portion, and is connected to a predetermined area of a circuit board that supplies the actuating signal or the driving current to diffuse heat generated from the light source.

2. An optical head device comprising:
a light source which emits a light beam;
a connecting portion which can supply at least an actuating signal or driving current to the light source;
a heat sink which diffuses heat from the light source;
a heat radiating element which is connected to the connecting unit, and is connected to a predetermined area of a circuit board that supplies the actuating signal or the driving current to diffuse heat generated from the light source; and
an objective lens which focuses the light beam from the light source onto a recording surface of an information recording medium in which information is recorded.

3. An optical head device according to claim 2, wherein the connecting portion includes a pin or a terminal to supply at least the actuating signal or the driving current to the light source on the light source side, and the connecting portion includes a portion having a large area or a large volume which is in contact with at least a part of a connecting area capable of performing electric contact on the circuit board side.

4. An optical head device according to claim 3, wherein a part of the light source side in the connecting portion includes the pin or the terminal and includes a portion having a large area or a large volume which is in contact with at least a part of the pin or the terminal.

5. An optical head device according to claim 3, wherein a part of the circuit board side in the connecting portion is connected to or in contact with a component having high thermal conductivity while the part of the circuit board side is connected to at least a part of the connecting area capable of performing electric contact.

6. An optical head device according to claim 3, wherein a part of the circuit board side in the connecting portion has a suppression portion which suppresses flow of a connection medium which can secure electrical continuity between the connecting portions of the light source side and the circuit board side.

7. An optical head device according to claim 3, wherein the connecting portion of the circuit board side is connected to the portion having the large area or the large volume which is in contact with at least a part of the connecting area capable of performing electric contact through a material having insulating characteristics and the high thermal conductivity.

8. An optical disk apparatus comprising:
an optical head device including:
a light source which emits a light beam;
a connecting portion which can supply at least an actuating signal or driving current to the light source; and
a heat radiating element which is connected to the connecting unit, and is connected to a predetermined area of a circuit board that supplies the actuating signal or the driving current to diffuse heat generated from the light source; and
an information processing circuit which reproduces information recorded in a recording medium on the basis of an electric signal outputted from a photodetector of the optical head device.

9. An optical disk apparatus according to claim 8, wherein the connecting portion includes a pin or a terminal to supply at least the actuating signal or the driving current to the light source on the light source side, and the connecting portion includes a portion having a large area or a large volume which is in contact with at least a part of a connecting area capable of performing electric contact on the circuit board side.

10. An optical disk apparatus according to claim 9, wherein a part of the light source side in the connecting portion includes the pin or the terminal and includes a portion having a large area or a large volume which is in contact with at least a part of the pin or the terminal.

11. An optical disk apparatus according to claim 9, wherein a part of the circuit board side in the connecting portion is connected to or in contact with a component having high thermal conductivity while the part of the circuit board side is connected to at least a part of the connecting area capable of performing electric contact.

12. An optical disk apparatus according to claim 9, wherein a part of the circuit board side in the connecting portion has a suppression portion which suppresses flow of a connection medium which can secure electrical continuity between the connecting portions of the light source side and the circuit board side.

13. An optical disk apparatus according to claim 9, wherein the connecting portion of the circuit board side is connected to the portion having the large area or the large volume which is in contact with at least a part of the connecting area capable of performing electric contact through a material having insulating characteristics and the high thermal conductivity.

14. A heat radiation mechanism comprising:
a heat source which generates heat by being supplied with an actuating signal or driving current;
a circuit board which provides at least the actuating signal or the driving current to the heat source;
a connecting portion which connects the heat source to the circuit board while electrical continuity is secured;
a heat sink which diffuses heat generated by the heat source; and
a heat radiating element which includes a portion having a large area or a large volume which is connected to or in contact with the connecting portion and diffuses head generated by the heat source.

15. A heat radiation mechanism according to claim 14, wherein the heat radiating element includes a metal or an alloy having high thermal conductivity.

16. A heat radiation mechanism according to claim 14, further comprising a spacer having insulating characteristics between the heat radiating element and the connecting portion.
